(19) United States
(12) Patent Application Publication
(10) Pub. No.: US 2014/0067841 A1
(43) Pub. Date: Mar. 6, 2014

(54) SYSTEM FOR IMPLEMENTING A CROWDSOURCED SEARCH FOR SOURCES OF INFORMATION RELATED TO A SUBJECT

(71) Applicants: Pedram SAMENI, Marina Del Ray, CA (US); Daniel PORTER, Los Angeles, CA (US)

(72) Inventors: Pedram SAMENI, Marina Del Ray, CA (US); Daniel PORTER, Los Angeles, CA (US)

(21) Appl. No.: 14/013,962

(22) Filed: Aug. 29, 2013

Related U.S. Application Data
(60) Provisional application No. 61/694,504, filed on Aug. 29, 2012.

(51) Int. Cl. G06F 17/30

(52) U.S. Cl. CPC G06F 17/30386
USPC 707/758

(57) ABSTRACT

Disclosed is an information collection system to collect sources of information relating to a subject from a plurality of users.

### CROSS-REFERENCE TO RELATED APPLICATION

The present application claims priority to U.S. Provisional Patent Application No. 61/694,504, filed Aug. 29, 2012, the entire contents of which are incorporated in full herein by reference.

### FIELD OF INVENTION

The present invention relates to collection of “sources” (which may comprise electronic documents, published papers, datasheets, patents, product or process specifications, etc.) from a plurality of users that may contain reference elements, which meet a predetermined criteria set by an administrator.

### BACKGROUND AND SUMMARY OF INVENTION

On any given subject, a great number of sources may be available. However, access to the sources may be hindered due to collective volume of information contained therein. Thus, searching for specific information in a large collection of sources is a very difficult task.

To some extent, electronic searching (e.g. word searching) has facilitated the searching process of large collections of sources. However, electronic searching is limited in that words cannot always express the intended context.

A source can be characterized to have a collection of “reference elements” (such as specific statements, descriptions, declarations, definitions, explanations, identifications, accounts, etc.). Each reference element may or may not be relevant to an intended search for information. A goal of an effective information search may be to locate particular reference element or elements within a source or sources on a given subject of inquiry.

Traditional searches use keywords and standard indexing methods to locate a desired reference element within a large body of potential sources. These searches are increasingly ubiquitous and accessible, but are not always effective for locating a desired reference element within a body of potential sources. In many such “keyword searches,” the results are typically too broad or too narrow, and therefore of little help. In the former case, there are many potential reference elements returned for a particular keyword that may or may not contain the desired information to respond to an intended search criteria. Alternatively the results may be too narrow. Because of differences in phrasing, language, word order, etc., conventional searches may miss important reference elements within a particular body of potential sources.

One solution to this problem is to “crowdsource” the search. That is, to distribute the search for responses to a particular query to a large number of individuals. The individuals will draw on their varied experience, background, preexisting knowledge, and access to more potential sources to more quickly and effectively locate sources that contain reference elements conveying the desired information to respond to an information search query. With a crowdsourced method, a searcher may leverage the knowledge of the individuals within a large search group to exclude irrelevant sources and ensure relevant ones are found. With the end goal being to locate a variety of reference elements that accurately respond to a particular query, pursuing a crowdsourced search strategy can be very effective.

One difficulty with executing a crowdsourced search is that the individuals recruited to perform the search may not always be entirely familiar with the subject matter, language, interpretation, format, terminology etc. of the query. As a result, these non-expert searchers may not be able to conclusively determine if a particular reference element (or elements) within a located source (or sources) is an acceptable response to a criterion (or criteria) in the original query. The individual initiating the search (presumed familiar with the subject matter contained within the query and able to judge the suitability of a particular reference element) must then sort through each response from the non-experts. If the body of non-expert searchers is large, the searcher once again has the problem of too many reference elements that may or may not respond to the original query.

A system according to the present invention provides a way for an administrator to distribute a search task to a plurality of users.

According to one aspect of the present invention, the system is configured to allow an administrator to present a search query to a plurality of users to collect reference elements form the users on a subject. The administrator may input the query into the system as a series of criteria that could be, for example, in the form of question statements which the users must answer and relate to specific references within a body of submitted sources.

In one embodiment, a system according to the present invention may contain a database of sources of which the administrator is already aware (“prior sources”), and the administrator may require the system to check that the user's submitted sources are not a part of the list of prior sources.

The system then intelligently presents the user with a series of questions or prompts based on the administrator's query to determine whether the user's reference elements are responsive to the query, and stores the responses in a database. The responses are then correlated by the system and the system outputs the results for the administrator to review.

The system could provide a variety of outputs to networked terminal computers, with the outputs ranging from a simple list of query criteria and matching source reference elements to more complex outputs based on the system's interpretation of the collective response of users.

Other features and advantages of the present invention will become apparent from the following description of the invention which refers to the accompanying drawings.

### BRIEF DESCRIPTION OF THE FIGURES

FIG. 1 illustrates source entry and verification components of a system according to the present invention.

FIG. 2 schematically illustrates questionnaire and reference element evaluation components of a system according to the present invention.

FIG. 3 illustrates a block diagram of a system implementation according to the first embodiment of the present invention.

FIG. 4 illustrates an administrator source submission form to obtain known sources from an administrator.

FIG. 5 illustrates an administrator criteria submission form to obtain from the administrator questions that are to be presented to the users.

FIG. 6 illustrates a user source submission form to obtain information relating to a source from a user.

FIG. 7 illustrates a user questionnaire form to obtain answers to questions presented by the administrator from a user.

FIG. 8 illustrates a process flow chart showing the flow of information into and out of a system according to the present invention.

### DETAILED DESCRIPTION

As used below “processor” refers to a computing device such as PC, or a server, which may or may not be associated with a display device, a printer or another output device.

As used below “program” refers to computer executable instructions.

As used below configured means programmed to perform a task.

As used below “terminal” is referring to a computing device such as a PC, a tablet, a laptop computer or the like that includes a processor and at least a display device associated with the processor.

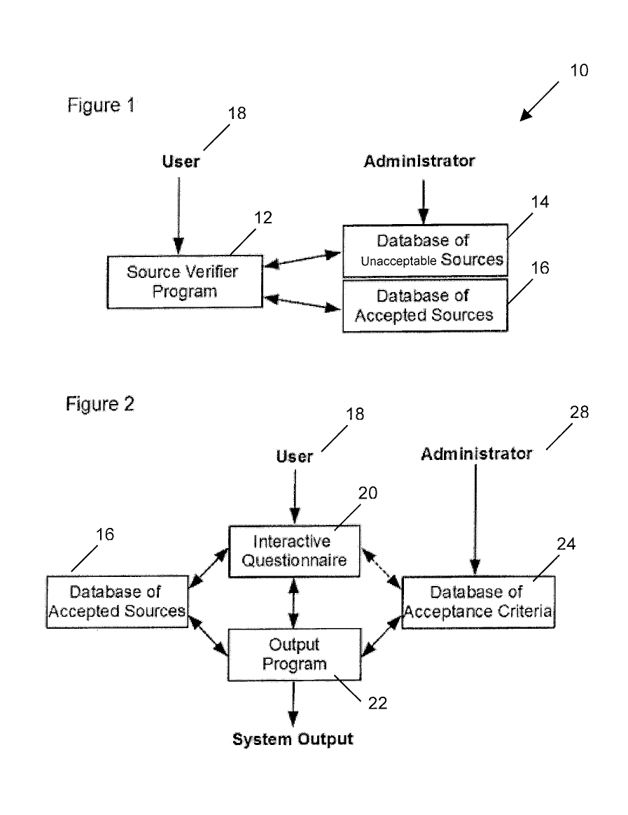

FIGS. 1 and 2 together illustrate interaction within a system according to the present invention. As further described below a system according to the present invention may include two distinct components: the source component and the questionnaire component.

FIG. 1 illustrates a high level illustration of a first component of a system 10 according to the present invention. The first component of system 10 may include at least a source verifier program 12, a database of unacceptable sources 14, and a database of accepted sources 16. As illustrated, system 10 receives information sources (e.g. patents, technical literature etc.) from a user 18. The information so received is checked against information in database of unacceptable sources 14 and the database of accepted sources 16 by system 10 according to an aspect of the present invention. Source verifier program 12 is used to configure a processor to check the acceptability of the user's submitted sources using the database of unacceptable sources 14 and database of accepted sources 16.

FIG. 2 illustrates a high level illustration of the second component of system 10 according to the present invention, namely, the questionnaire component, which includes at least an interactive questionnaire program 20, an output program 22, a database of acceptance criteria 24 (e.g. questions relating to a subject), and database of accepted sources 16. System 10 receives information defining the acceptance criteria from a system administrator 28, and information about a user's submitted source(s) through input into an interactive questionnaire generated by questionnaire program 20. Output program 22 generates an output based on user responses and accepted sources, and further produces a displayable output or printout to administrator 28 of system 10.

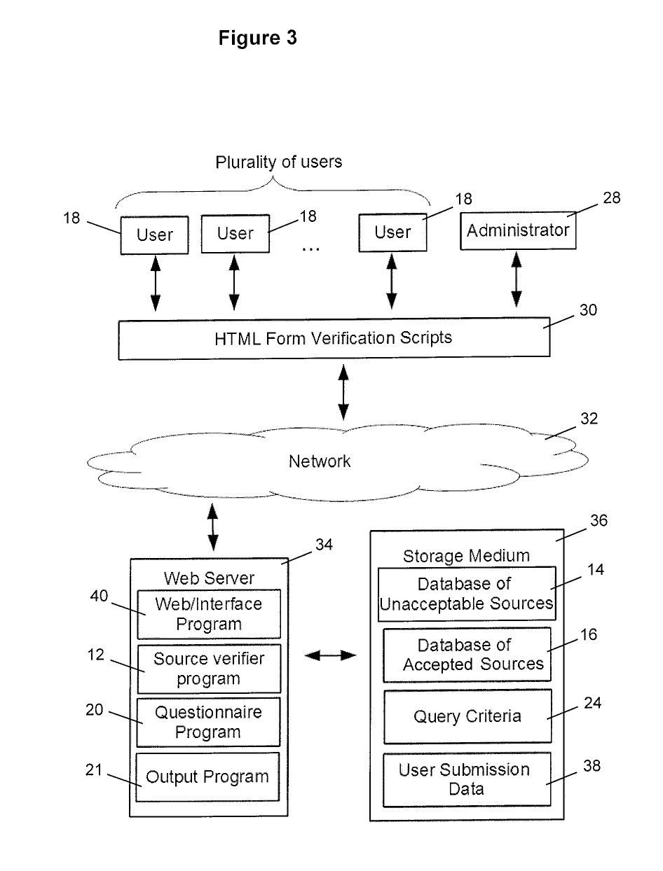

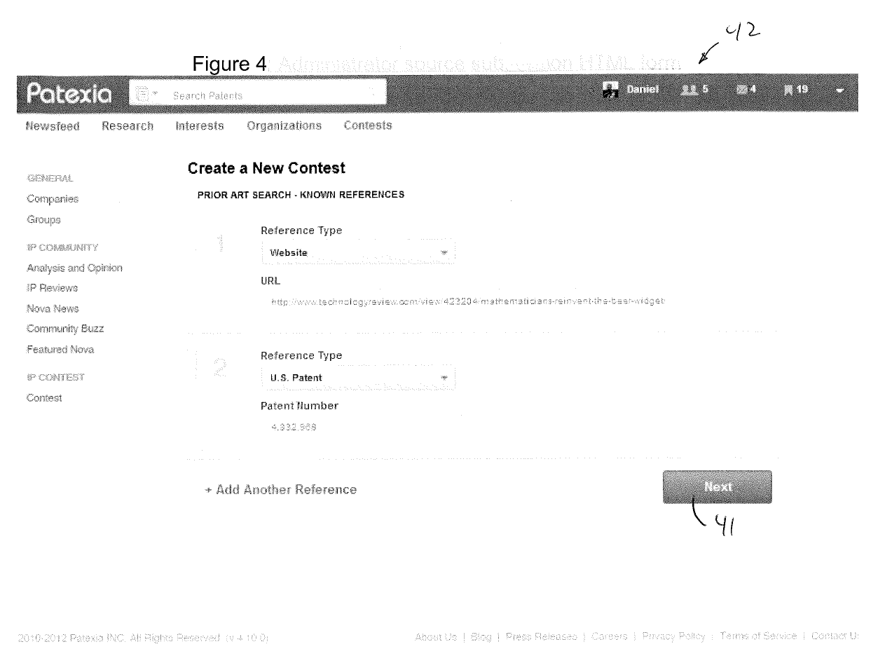

FIG. 3 is a block diagram of a system 10 according to an embodiment of the present invention. In this embodiment, administrator 28 and a plurality of users 18 interact with a central processor (which may be one or more processors) by submitting and receiving information through HTML forms. The HTML forms pass form submissions through verification scripts 30 to check entry formatting before exchanging the data over a network 32 with the central processor located on a web server 34, which may be one or more processors on which web interface program 40, source verifier program 12, questionnaire program 20 and output program 21 reside. In this way, users 18 can submit their sources over network 32, and web server 34 provides access to the components of system 10. The central processor may include a storage medium 36 (which can be one or more electronic storage devices such as hard disks, or nonvolatile memory storage devices for non-transitory storage of data) containing database of accepted sources 16, database of unacceptable sources 14, database of acceptance criteria 24, and a database 38 for storage of data collected from users 18, administrator 28, and their respective inputs. In this embodiment, web interface program 40 configures a processor in web server 34 to generate HTML forms displayed to users 18 and administrator 28, and output program 21 configures a processor in web server 34 to provide an output to a user terminal or to a terminal associated with an administrator.

FIG. 4 shows an example of an administrator source-submission HTML form 42 generated by web interface program 40. System 10 generates a version of this form for administrator 28, sending it over network 32 where it is displayed on the administrator's terminal (e.g. a display associated with a personal computer). Form 42 allows administrator 28 to submit identifiers (e.g. patent numbers, literature citations etc.) of unacceptable sources to the database of unacceptable sources 14. Administrator 28 selects the type of reference and inserts information (an identifier) identifying that particular reference into the appropriate fields. When a completed form 42 is submitted, system 10 stores the submitted identifier(s) in database of unacceptable sources 14.

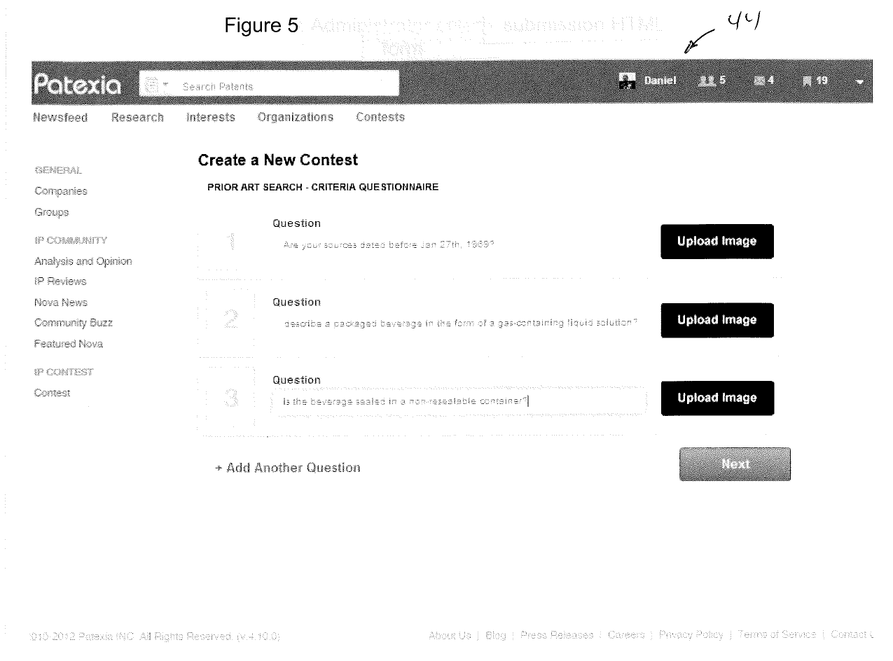

FIG. 5 shows an example of an administrator criteria-submission HTML form 44 generated by web interface program 40. System 10 generates a version of this form for administrator 28, sending it over network 32 where it is displayed on the administrator's terminal. Form 44 can receive a criteria from administrator 28, for example, in the form of questions to which users 18 will respond. Administrator 28 enters the questions into the displayed fields in form 44 and submits the completed form 44 to system 10. After a verification script from HTML form verification scripts 30 checks the formatting of the inputs, system 10 stores this input and uses it to create a questionnaire for users 18.

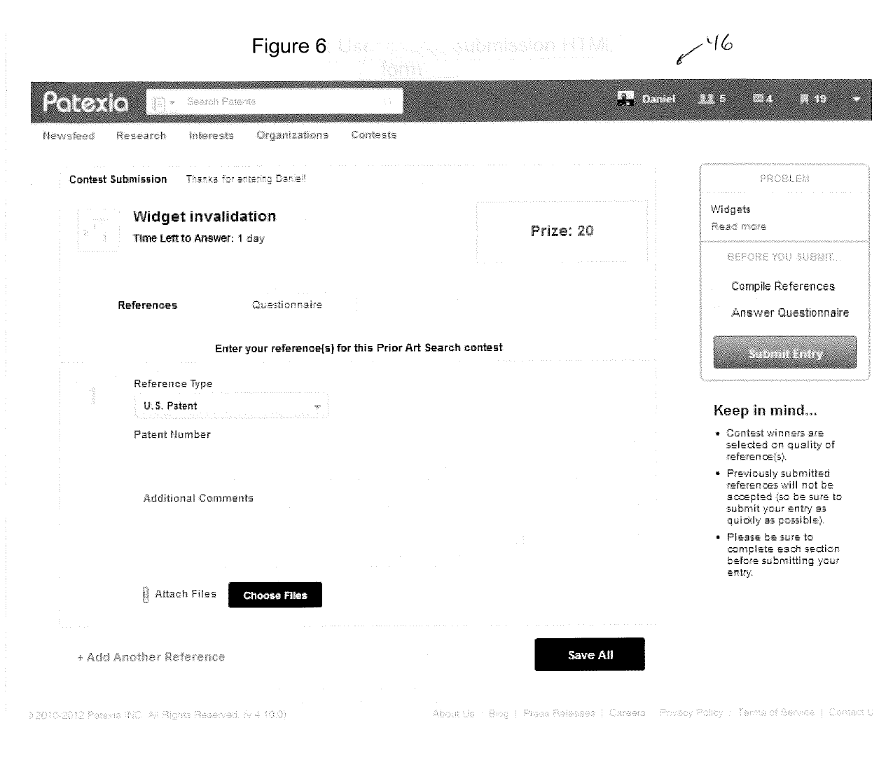

FIG. 6 shows an example of a user source submission HTML form 46 generated by the web interface program 40. System 10 generates a version of this form for each user 18 of system 10, sending it over network 32 where it is displayed on a user's terminal (e.g. a display associated with a personal computer). Forms 46 receives input from a user 18 to identify a source (an identifier) the user 18 is submitting. After a verification script from HTML form verification scripts 30 checks the formatting of the user input, system 10 passes the input to the source verification program 12, which will determine whether the source is acceptable. If the source is unacceptable, source verifier program 12 instructs web interface program 40 to generate a message for the user in the form of an HTML document, which is sent over network 32 and displayed to user 18 indicating that the submitted source is unacceptable.

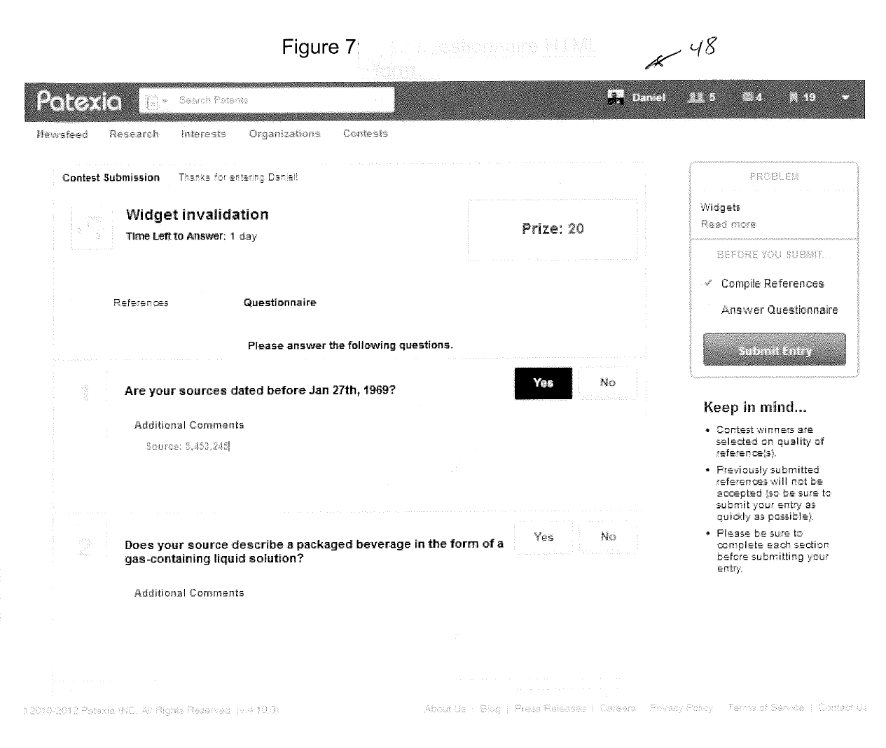

FIG. 7 illustrates an example of a questionnaire HTML form 48 generated for each user 18 by web interface program 40. System 10 generates a version of form 48 for a user 18, sending it over network 32 where it is displayed on the user's terminal. Form 48 receives input from the user 18 in response to the criteria established by administrator 28. After a verification script from HTML form verification scripts 30 checks the formatting and parses the user inputs, system 10 passes the resulting data to questionnaire program 20, which stores each user's information in the database of user submissions 38.

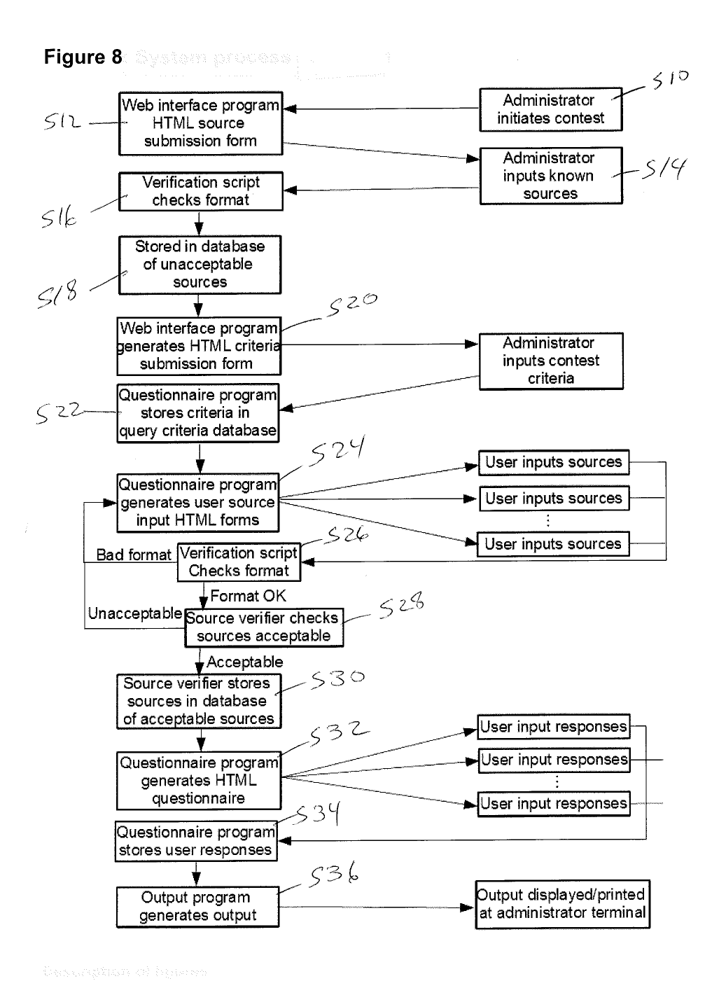

FIG. 8 illustrates the process flow of a system according to an embodiment of the present invention. In particular, FIG. 8 illustrates how a system 10 presents information to users 18 and administrator 28, how it processes through programs on web server 34, and how it stores information in the databases residing in storage medium 36. The column on the left illustrates system actions, and the column on the right indicates user 18 or administrator 28 actions.

Referring to FIG. 8, a system 10 according to the present invention may be configured to implement a contest in which a plurality of users 18 participate in a search for relevant information on a subject, such as a claim of a patent or patent application. An administrator 28 may devise the contest. An administrator 28 initiates a contest S10, by, for example, requesting via a computer terminal a form 42 from web server 34. Web server 34, in response to the request, sends form 42 to the administrator's terminal. Administrator 28 then fills out form 42 at his/her terminal S14, the format of which is preferably checked at the administrator's terminal S16 by a script that is supplied by web server 34. Alternatively, the format checking may be carried out by web server 34. Once a source identifier is received by web server 34 from the administrator, it is stored S18 in the database of unacceptable source 14. Administrator 28 can then request, via his/her terminal, form 44 web server 34 in order to provide questions that are to be presented to users 18 regarding the subject of the search. Web server 34 sends form 44 to the administrator's terminal 520, and then receives filled out form 44 from the administrator's terminal and stores S22 the question in query criteria database 24.

Each user 18 can then request, via a terminal, a form 46 from web server 34, and web server 34 can then send a form 46 to each requesting user S24. Each filled out form 46 is then checked for proper format S26 by a script that is preferably provided by web server 34 to the user terminal. Alternatively, the format checking may be carried out by web server 34.

If the format is acceptable, then web server 34, checks to determine whether the identifier provided by the user is in the database of unacceptable sources S28. If so, a message is sent to the user identifying that the source is unacceptable. If not, web server 34 checks to determine if the submitted identifier is in the database of accepted sources S28. If so, a message is sent to the user indicating that the submitted source is unacceptable. If not, the submitted source is deemed acceptable and stored in the database of accepted sources S30. Thereafter, web server 34 sends S32 a questionnaire based on questions provided by the administrator (see S22) to a user's terminal whose source has been accepted, and, once answers are received, the answers are stored S34 in database of user submissions 38. The process is repeated for very submission. After the contest has ended, system 10 can generate an output that includes the results of the search content S36.

A specific implementation of a system according to the disclosed invention is a system for conducting a prior art search over a network of computers for the purposes of determining patentability. In the disclosed implementation, the system helps an Administrator 28 find a collection of sources and reference elements that would serve as prior art against a claim in a particular patent or a patent application. The result of the prior art search could be used for the purposes of invalidating a claim of a patent, or used to determine the patentability of a not-yet-patented claim, producing output in the form of patentability reports instead of patent invalidation reports.

The system is preferably implemented with a website to provide HTML pages to an Administrator 28 and users 18 for which users 18 register and are subsequently able to log on and interact with the system components. Administrator 28 and users 18 interact with the system through HTML pages displayed on web browsers running on networked terminals (e.g. computers).

The following example demonstrates the operation of a system according to the present invention for collecting source elements that could be used to assess the validity of a claim in a patent (e.g. British patent number 1266351 for “Improved method of and means for dispensing carbonated liquids from containers,” an invention currently in use and more commonly known as a “widget”). A portion of the first claim is reproduced below:
A packaged beverage in the form of a liquid containing gas in solution, sealed into a non-resealable container (as herein defined) having a main compartment and a smaller subsidiary compartment, and comprising a predetermined volume of the liquid carried in the main compartment under pressure from gas in a headspace above the liquid substantially in equilibrium with the gas in solution in the liquid, and a charge of gas under pressure in the subsidiary compartment, the subsidiary compartment communicating with the main compartment through a fine aperture constituting a restricted flow jet nozzle and located below the surface of the liquid, the arrangement being such that [ . . . ]

Administrator 28 inputs information that identifies unacceptable sources into an administrator source submission HTML form (e.g. form 42, FIG. 4). For example, administrator 28 may input identifier(s) relating to prior art that was considered during the prosecution of the patent and information relating to any other prior art reference that is known to administrator 28. Once the form is complete, by clicking the NEXT button 41, the information is sent to and received by web server 34 (see FIG. 3) and then stored in database of unacceptable sources 14. In order to obtain information from a user 18 in an orderly manner, a group of questions are presented to user 18 by system 10. In this example, the questions are devised by administrator 28 and stored in query criteria database 24. The criteria put in place by administrator 28 are plain-language questions which administrator 28 has created to simplify claim analysis. FIG. 5, for example, is an example of an HTML form 44, which can be sent by administrator 28 and used to populate database 24. For example, administrator 28 might input the following questions, using the administrator criteria submission HTML form 44, based on the claim or claims he seeks to evaluated:

1. Are your sources dated before Jan. 27, 1969?

2. Does your source describe a packaged beverage in the form of a gas-containing liquid solution?

3. Is the beverage sealed in a non-resealable container?

4. Does the main compartment of this container contain a smaller subsidiary compartment?

a. Does this subsidiary compartment contain a volume of the same liquid as the main compartment?

b. Does this subsidiary compartment contain a charge or gas under pressure?

c. Is the liquid in the subsidiary compartment under pressure from gas in the headspace of the container?

d. Does the compartment communicate with the main compartment through a fine aperture constituting a restricted flow jet nozzle?

e. Is the nozzle located below the surface of the liquid?

5. Is there gas in a headspace of the container in equilibrium with the gas in the solution?

The goal of presenting the questions is to locate prior art that discloses the subject of a claim in the patent. Users 18 will be preferably presented with a copy of the patent in question as part of a simple web-page explaining the goal of the search. After a user agrees to participate in the search, which involves agreeing to a document containing terms and conditions, the system presents user 18 with a contest module, in the form of an HTML file displayed on a web browser (see, for example, forms 46 and 48 in FIGS. 6 and 7, respectively), which allows for interaction with the system. The contest module HTML form is presented in two parts, both of which the user can alternately access at any point throughout interaction with the system.

The “References” or “Sources” part of submission form 46 preferably sent first to each user 18, allows each user 18 to interact with source verifier program 12. The form prompts each user 18 to input one or multiple identifier of sources which may be relevant. These identifiers of references could be in the form of addresses linking to networked documents, reference citations (such as a US patent number or peer-reviewed journal citation) which would allow the system or Administrator 28 to look up a particular source, or a self-contained document such as a plaintext file or PDF file uploaded to the system.

After user 18 inputs and submits a completed source form 46, the HTML module interacts with a preliminary HTML form verification script that checks the hyperlink or journal reference for proper text formatting, or an uploaded document for file format before sending it to the central processor over network 30. The central processor, by way of the source verification program 12, will check whether that source is already in the database of unacceptable sources 14. If the source exists already in the database of unacceptable sources 14, the system will send the user a message by way of the source submission form informing him that his reference is not acceptable. If the source already exists in the database of acceptable sources 16, submitted by another user 18, the submitting user 18 will be notified that the source has already been submitted. Otherwise, the source will be stored in the database of accepted sources 16 with information about the user who submitted the source, as well as date and time information. Thus, as discussed above with reference to FIG. 8, when a source is accepted (i.e. not found in the database of unacceptable sources 14 and the database base of accepted sources 16) then the submitted source is added to the database of accepted sources. Note that each submission is associated with a time and a date of submission in association with the user who submitted the reference when added to the database of accepted sources, whereby the system can generate a report of when each submission was accepted from each user 18 so that the first user to submit an acceptable reference or references can receive the proper credit. The system then presents the user with the questionnaire HTML form.

The “Questionnaire” part of the module (e.g. form 48, FIG. 7) allows the user to interact with the system through an HTML form displayed on a networked terminal. The questionnaire form prompts the user to answer the administrator's questions, as well as to provide additional information, including which source from a user's submitted sources corresponds to a particular question and where within that source the information to support the user's answer can be found.

A preliminary verification script ensures that each of the inputs are valid, that patent numbers or patent application numbers exists, that internet addresses are formatted correctly, and that uploaded files are in a readable format. The verification script then sends the data—the user's responses—to the questionnaire program on web server 34 for processing and storage. When the questionnaire program 20 receives the user's responses to the questions, it stores the information in the database of user submission data 38. The information so stored will associate each response from user 18 to a source stored in the database of accepted sources 16. Thus, the system will be able to store and track each user's responses.

As the system stores information about the user sources and responses, questionnaire program 20 can use this information in conjunction with information stored in the other databases to modify the questionnaire form as it is presented to other users. Some examples of how the system might modify the questionnaire are:

1. If source verifier program 12 is able to determine and verify the date on the sources, it will remove question 1 from the list.

2. If an overwhelming majority (example, more than 75%) of users 18 respond in the negative to one of the questions, the system can remove it and notify administrator 18, potentially indicating an ineffective phrasing of the criteria for a particular claim or portion of a claim.

3. If many users 18 reference the same source to respond to a particular question, the system can remove the question from the list and notify administrator 28, effectively eliminating questions which have an “obvious” answer. For example, if many users reference a particular source for question 3, the system will remove it from the list so that future users can progress through the questions without wasting time invalidating a claim for which the system has already discovered prior art.

4. The system can present “sub-questions,” to extract more detail. For example, if the user answers “yes” to question 4, the user would be presented with the subsequent parts to determine whether the claim relating to question 4 is invalidated by the user's source. If the user answers “no” to question 4, the system would remove subsequent parts of question 4 from the questionnaire presented to that particular user.

From the sources and responses to questions collected, the system can return a wide variety of reports. If the system is able to determine that a user's sources are relevant to one or more of the claims based on the criteria established by administrator 28, the system then outputs results in the form of a plaintext list, an HTML list, a chart image, or a spreadsheet displayed on the administrator's networked terminal that correlates each claim to the invalidating reference elements among a list of sources and lists these claim/reference pairs one-by-one. This list shows in a straightforward manner which ideas are potentially unpatentable based on the existence of prior art disclosed in the submitted sources and information within sources submitted by either a single user 18 or the collection of users 18 in aggregate. The system can also output a plaintext or HTML list, sent to the administrator's networked terminal, of all the sources which users 18 added to respond to particular question or set of questions, as well as statistics about how many users gave a particular response to any of the questions.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An information system configured to collect sources of information relating to a subject from a plurality of users, the system comprising:
a processor configured
to receive from an administrator a first identifier that identifies a known source of information relating to said subject, and storing said first identifier in a database of unacceptable sources;
to receive from at least one of said plurality of users a second identifier of a potential source of information relating to said subject;
to compare said second identifier received from said at least one user to said first identifier stored in said database of unacceptable sources; and
to store said second identifier in a database of accepted sources if said processor determines that said second identifier is not in said database of unacceptable sources.

2. The information system of claim 1, wherein said processor is configured to store said second identifier along with a time and a date in association with said at least one user.

3. The information system of claim 1, wherein said database of accepted sources includes at least one identifier, and wherein said processor is further configured to compare said second identifier to said at least one identifier in said database of accepted sources, and to store said second identifier in the database of accepted sources if said processor determines that said second identifier is not in said database of acceptable sources.

4. The information system of claim 3, wherein said processor is configured to send said at least one user a message indicating that said second identifier is unacceptable if said processor determines that said second identifier is in said database of unacceptable sources or in said database of accepted sources.

5. The information system of claim 1, wherein said processor is further configured to receive from said administrator at least one question, to store said at least one question in a query database, to send said question to said users, to receive an answer to said at least one question from each user, and to store each answer received from each user in a user submission database.

6. The information system of claim 5, wherein said processor is a web server.

7. The information system of claim 6, wherein said processor is configured to receive said first identifier and said second identifier via a network.

8. The information system of claim 5, wherein possible answers to said at least one question is YES or NO, and said processor is configured to remove said at least one question when said at least one question receives a NO from a number of said users.

9. The information system of claim 5, wherein possible answers to said at least one question is YES or NO, and said processor is configured to remove said at least one question when said at least one question receives the same answer from a number of said users.

10. The information system of claim 9, wherein said subject is a claim in a patent, and said question relates to date of public availability of said potential source of information.

11. A system configured to collect sources of information relating to a subject from a plurality of users, the system comprising:
a. an electronic storage medium or media including a database of unacceptable sources, a database of acceptable sources, a database of acceptance criteria defining a query received from an administrator, and a database of user submission details; and
b. a central processor configured to perform source verification in communication with the storage medium or media, which is configured to check that a source received from a user is not present in the database of unacceptable sources or the database of accepted sources before storing said received source in said database of accepted sources, and to generate a questionnaire based on said acceptance criteria, to send said questionnaire to each said user, to receive responses to said questionnaires from said users, to store said responses in said database of user submission details, and to produce an output based on said responses.

12. The system of claim 11, wherein the subject is a claim in a patent, the query is a prior art search, the sources are published documents, and the output is a chart, a table, or a list which correlates said claim with references received from said users.

13. The information system of claim 11, wherein said central processor is configured to store in said database of user submission details a time and a date of receipt of a source from a user in association with said user.

14. The information system of claim 11, wherein said central processor is configured to send a message to a user indicating that a source received from said user is unacceptable if said central processor determines that said received source is in said database of unacceptable sources or in said database of accepted sources.

15. The information system of claim 14, wherein said central processor is a web server.

16. The information system of claim 11, wherein said query is sent to said users in the form of at least one question, wherein the possible answers to said at least one question is YES or NO, and said processor is configured to remove said at least one question from said database of acceptance criteria when said at least one question receives a NO from a number of said users.

17. The information system of claim 11, wherein said query is sent to said users in the form of at least one question, wherein the possible answers to said at least one question is YES or NO, and said processor is configured to remove said at least one question from said database of acceptance criteria when said at least one question receives the same answer from a number of said users.
